(19) United States
(12) Patent Application Publication
(10) Pub. No.: US 2017/0185932 A1
(43) Pub. Date: Jun. 29, 2017

(54) Computer System and Method for Organizing Project Data

(71) Applicant: Summit Lender Services, LLC, Frisco, CO (US)

(72) Inventor: David Hynds, Houthalen (BE)

(73) Assignee: Summit Lender Services, LLC, Frisco, CO (US)

(21) Appl. No.: 15/260,786

(22) Filed: Sep. 9, 2016

Related U.S. Application Data
(60) Provisional application No. 62/216,300, filed on Sep. 9, 2015.

(51) Int. Cl. G06Q 10/06

(52) U.S. Cl. CPC G06Q 10/06313

(57) ABSTRACT

A solution that will track the progress of a project having a plurality of participants, milestones and budget, along with all the draws and advances made during the project, facilitate the periodic inspection process of the project, maintain a collection of photographs and other notes and comments during the project inspections, and maintain a proper workflow for the projects to ensure that inspections are made in a timely manner and draws are processed and disbursed by the proper personnel and in a timely and accurate manner by using a queue system to advance and track the draw and inspection requests through the system is described.

### CROSS REFERENCE TO RELATED APPLICATIONS

This application claims benefit of priority from U.S. Provisional Application No. 62/216,300 filed Sep. 9, 2015, which is hereby incorporated by reference in its entirety for all purposes.

### BACKGROUND OF THE INVENTION

In most development projects, namely those related to the construction industry (hereinafter referred to as “project” or “projects”), time are parties to the project with a vested interest in the timely and on-budget completion of the project (Vested Party). These Vested Parties are typically the developers and financiers of the project, although there may be other parties with such a vested interest to whom the present invention is also beneficial such as insurers and lien holders. In order to protect their interest in the project, the Vested Parties have a need to monitor progress of the project closely from several perspectives.

First, the vested parties have a need to monitor the budget of the project, including monitoring each of the monetary advances (draws) made for payment of contractors, sub-contractors and suppliers of goods and services related to the completion of the project. This monitoring should include a line-by-line view for each budget line item that is listed in the project's budget. During this review, the Vested Party should be actively looking for any budget line items where it appears there may be insufficient funds available to complete the project as planned.

Next, the Vested Parties have a need to monitor the progress and actual completion of the project on-site. This would entail an inspection process, and may be completed by the Vested Parties themselves, or by outside parties that are hired to perform the inspections on the project. These inspections should include a line-by-line review of the key items involved in the completion of the project. These inspections should be completed both to ensure that the monies that are being disbursed during a draw are being disbursed for items that have actually been delivered, installed and/or completed at the job site, as well as to ensure that the Vested Party is not disbursing funds in advance of completion. For example, a Vested Party in a building under construction will want to first ensure that if they are disbursing funds for a roof, that the roof is adequately installed on the structure. Second, the Vested Party will want to ensure that if they are disbursing funds for partial payment, e.g. 50% of the cost of the roof as a type of progress payment, that the roof is approximately and satisfactorily one-half completed.

It is also useful for a Vested Party to have the inspections of the jobsite include photographic evidence, as well as comments from the inspectors related to the progress of the project. These comments could be regarding the project in general, such as “There appears to be no progress in the past 30 days”, or about specific items, such as “The drywall contractor appears to have allowed the drywall to be rained upon, and therefore ruined beyond repair and in need of replacement”. These comments and the related photographs are helpful to the Vested Party in making its decision to advance the funds requested for a draw, and facilitate decisions about whether to progress to or delay other steps of the project.

The Vested Parties also have a need to track projects that have draw requests pending, and to ensure that personnel with the proper experience and approval/authority levels are then reviewing the draw requests for approval or denial in a timely manner, and that tracking the entire process is maintained and preserved for at least the term of the project.

Inspectors involved in a project also have specific needs for data while on-site, in order to perform their inspections in the best possible manner. These needs include being able to instantly reference specific information about a project, in addition to potentially needing to access specific past inspection reports and/or draw requests, regardless of the funding status.

Finally, other parties (such as insurers, lien holders and tenants), not necessarily involved in the direct completion of a project, have needs for data processing and recording the progress of construction projects. As there are often legal or accounting issues that arise during and after construction projects, these parties have a need for consolidated reporting of the specific progress of a project, both from the funding aspect, for example, recording each draw request, its contents and approval/denial; as well as from the inspection history of the project, for example, each on-site inspection, along with related notes on the progress and photographic proof of the progress, as well as potential issues in the construction process that may not be outwardly visible or apparent when the project is completed.

Based on these requirements and best practices, a solution is needed that will track a project's progress, milestones and budget, along with all the draws and advances made during the project, facilitate the inspection process occurring at periodic points in the project, maintain a collection of photographs and other notes and comments during the project inspections, and maintain a proper workflow for the projects to ensure that inspections are timely made and draws are processed and disbursed by the proper personnel and in a timely and accurate manner by using a queue system to advance and track the draw and inspection requests through the system, that has not been available in the prior art due to complexities inherent in the human and automated systems for processing such data from multiple input points and platforms, at often overlapping periods of time.

At the same time, the solution must maintain the proper records in order to be a reliable database of information on the project's progress, especially if needed in an audit and/or legal situation. The solution must also be customizable by the Vested Party to ensure the ability to facilitate a variety of types of construction development projects. Given the many different and often overlapping aspects of a construction project over multiple stages before its completion, including the concurrent and divergent work of the contractors and sub-contractors preparing and submitting invoices and draw requests, the Vested Parties' processing, reviewing and approving draw requests, and the inspectors that are ensuring the completion of the project and accuracy of the draw requests, there exists a need to process data from various inputs and from one or inure locations and stakeholders (Vested Parties) that can make the project development, management and funding process more efficient and expedient, less prone to errors by humans or multiple automated components, less vulnerable to miscommunication and more accurate and accessible for long term record keeping.

### BRIEF SUMMARY OF THE INVENTION

The present invention is related generally to a system for data collecting, processing, organizing and retaining data for multiple participants of a development project. This software as a service innovation comprises three main systems: the web portal, the database, and the mobile inspection applications. The invention relates more specifically to a cloud based database system that is accessed online via a web browser and Android and iOS applications in which a party with a vested interest in the progress and completion of a construction or development project can input or track the status of the budget, schedule and loan for the project, each draw request and interest reserve advance on the project, development milestones, and electronically complete in-person inspections of the project with a portable electronic device (PED) such as a hand-held smartphone.

### BRIEF DESCRIPTION OF THE DRAWINGS

The invention is illustrated by way of example and not limitation in the accompanying drawings.

FIG. 1 shows the general architecture of the system components, along with the communication paths between the components.

FIG. 2 is a flowchart illustrating the steps users generally will perform in the system for inputting a project, processing draw requests and processing inspections.

FIG. 3 is a flowchart illustrating the draw request processing queue system that is used in the invention to accurately group projects based on their next needed actions.

FIG. 4 is a flowchart illustrating the inspection process that is used in the Inspector portal feature of the invention in order to record in the database the progress on the project at any given time.

FIG. 5 is a sample user interface screen of an embodiment of the present invention.

### DETAILED DESCRIPTION

For the purposes of this description, there are generally five types of users of the system and method of the present invention, four that are end users and one that is an administrative user of the system (that may be referred collectively herein as “Users”). They are described as follows:

Lending Institution User or “LIU”—This Vested Party is a general user, typically from a financial institution. This user will be involved in the inputting of data, draw requests and inspection requests. This user will also be involved in the approval of draw requests, as well as moving projects between queues. Each user is assigned an approval level in the invention, and is only allowed to make material modifications to projects with an approval level less than or equal to their approval level. An LIU will perform all of their typical work in the web portal functionality of the invention. An LIU may also be an “Inspector” in the program.

Inspector—This user will not be granted access to the web portal functionality of the invention but will have access to a limited portion of the system database via a system interface screen specific to the inspection process. An inspector will be utilizing the mobile applications in order to perform the on-site inspections requested by the LIUs, which are then reported back to the central database from the mobile applications.

Super User—This is an Administrator of the System for all Users of an account of a Vested Party, typically at a financial institution or Project Developer. A Super User will have the ability to create other users according to their product license, set up certain functionality in the invention, and perhaps also be granted the same rights and abilities as an LIU.

Contractor—This is a limited user of the system with correspondingly limited access to the system features and data, typically related to the entities performing the work on the project. This user is envisioned to have the ability to input data related to draw requests into the system, that would then trigger the events in the draw request processing and inspection systems the LIU has in place. This user would also be able to view the status of draw requests and the history of draw requests and inspections, however would not be able to manipulate this data.

Staff User—This is an Administrator of the System for all the Users. This user has the ability to set up institutions, and all accounts for Users, etc., as well as perform all the functionality of each of the Users previously mentioned.

Note: LIUs, Inspectors, Super Users and Contractors may be referred to individually or collectively as “End Users”.

Web Portal: The web portal is the computerized point of system access where a Vested Party will perform the majority of inputting of information regarding a project, as well as viewing or accessing the processed and organized data. This is where the Vested Party will initially manually enter or electronically scan or retrieve information for input into a computer having processing circuitry and memory circuitry to enable processing of algorithms for the processing of data described herein. The information submitted initially is regarding the location and type of construction/development project, in addition to information about the project's budget that may be either manually entered or electronically loaded from a spreadsheet. During this process, the Vested Party will designate from a custom list, the type of project that is being completed, which will then determine the Completion Weighting Items (CWI) described further below that will be used during the inspection of the property in determining the overall percentage of completion of the project. These tasks are completed at a computer terminal or portable electronic device (PED) having processing power and internet connection where web portal access can be accomplished via user registration and log in. Users are designated by authorized Vested Parties or other authorized users of the system, and are herein referred to as “Users”. It is also contemplated that information can be inputted when an internet connection is not available, and stored until connection is restored and the data can then be electronically transmitted.

On an ongoing basis, the Vested Party will continue to utilize the web portal functionality throughout the life of each project. When a draw request to advance funds is received by a Vested Party, that system User authorized by the Vested Party will enter the request into the web portal. The web portal is then accessed and utilized by the Users having the proper approval levels in the program to review and then approve or deny the draw request. In an alternate embodiment, the request to advance funds can be input or uploaded directly into the web portal by the contractors and sub-contractors, which then becomes a triggering event that is acknowledged by a Vested Party through a prompt on the Web Portal or communication to that Vested Party sent by the system, which would further streamline and shorten the draw process timeframe, as well as reduce the chance for errors. Such errors that might be found include, but are not limited to, funding a draw request of an improper amount, or at the incorrect time, or not funding at all when appropriate, causing delays or other problems to the project.

The web portal is also used by the Vested Party to request and review inspections on the projects, for example when a draw request is received, it is often necessary for an inspection of the current status of the project to occur before the release of some or all of the funds for that milestone may be approved. The User is able to select an inspector to request that an inspection be completed at any time, or may pre-set in the system their preference upon certain trigger Milestone events according to the Vested Party's practices and policies. When an inspection is requested on a project, if a specific inspector is assigned to the inspection, that inspector is notified via email or other electronic or phone communication designated to perform the inspection, otherwise the inspection request is put into the “Unassigned” inspection queue for that Vested Party, and all inspectors assigned to the Vested Party have access to the inspection request and may conduct the inspection if appropriate, in which case if one of multiple inspector candidates opts to take the inspection assignment for the project, a designation is made in the system so that other inspectors know that the inspection is already assigned. Once the inspection is completed by the inspector, the Vested Party is notified via email, text message, or other designated notification delivery that the inspection has been completed, and the Vested Party is able to view the percentage of completion the inspector has assigned to each CWI, as well as to review any photographs and notes by the inspector, either in general on the project, or related to specific CWI.

The Vested Party will use the web portal's queue system and, in an alternate embodiment, the Milestone Calendar, Timeline, or Schedule to track each project in the database throughout the inspection and draw request processes. Loans will be moved from one status to another either through specific actions, for example, when an inspector completes an inspection, a loan may move from “Waiting for Inspection” to “Ready for Approval” system designation, or may be made manually by the Vested Party.

The web portal will also provide to the Vested Party a series of reports regarding the status of the projects in the database, as well as specialized reports related directly to potential negative issues on the projects, based either on numerical comparison of items like the percentage of completion versus the percentage of funds disbursed, or on factors such as projects taking a longer period of time to complete than expected, based on Milestones missed or Schedule delays. The Milestone/Schedule feature allows Vested Parties to better manage their portfolio of projects by tracking the completion of the project and usage of the budgeted funds in comparison to the project's expected timeline and/or loan maturity. In addition, it will assist other Vested Parties, such as insurers and potential tenants regarding the anticipated completion of the project. Reports may also include tools for the Vested Party to make projections about cash needs to satisfy draw requests, as well as projections of repayment of projects to meet its creditors' demands. The web portal is also where the Vested Party will be able to access a complete history of each project, including all draw requests, all draw approvals/denials, and all inspection results, including photographs and comments from the inspectors. All this data is time and identity stamped by the person who submitted information, or inspected or approved each step as that information is inputted into the system.

Database: The database portion of the invention is preferably a cloud-based system where storage of the data could be physically based at any location. As the users of the system are accessing the system via the Web Portal using any standard internet web browser, the actual location of the database is not important, so long as there is a reliable internet connection to it.

While the database is, for all general purposes, one large database for all Users of the system, it is basically partitioned into different databases virtually, one for each Vested Party. A User's username or account information to the program ties the User to those features he/she has access and determines the area or areas of the database to which they will have access. For example, a User for one Vested Party, in general, will not be able to access the projects in the database for other vested parties. Further, an inspector would not have access to the database via the web portal. Another example is that multiple Vested Parties may be allowed to authorize the same inspector to access their data.

Mobile Inspection Applications: The mobile inspection applications for this invention are the tools that will be used to perform inspections of construction projects. There are two separate inspection applications at this time, one each for Android and iOS operating systems. The two applications are nearly identical in look and functions and it is understood that additional similar applications could be used for other devices or operating systems.

Once installed on the inspector's portable electronic device (PED), such as a smartphone or tablet, the inspector is able to access the Mobile Inspection Application through a log in to a limited portion of the system database via a system interface screen specific to the inspection process. Once logged in, he/she will be able to view the inspections that the Vested Party has requested the inspector perform, as well as a listing of any inspection requests from the Vested Party that are not assigned to an individual inspector (Unassigned). In a preferred embodiment of the system, the inspector will not have access to the full functionality of the web portal, in order to minimize the risk of data corruption, to ensure data privacy, and to allow the inspections to be completed in a way that is as non-biased as possible.

On each individual inspection request, the inspector is able to view key data regarding the project, as well as a map to the project, the previous draw requests, previous inspections, and previous photographs and notes on the project.

This is also the area where the inspector can input the results from the current inspection by scrolling through the Completion Weighting Items (CWI) assigned to the project and using an icon to select the percentage that each of these CWIs is completed at this time. At the same time, the inspector is able to take pictures and make notes that are related to individual CWIs or can add photos and notes to the overall project, which are then included with the inspection that goes into the database.

Once the inspector has finished reporting the percentage of completion for each CWI, as well as added any photos and notes they wish to include, they are prompted to submit the inspection results. At that time (or once an internet connection is available), the data input into the PED device by the inspector for that property is transmitted back to the database. The system then will notify the Vested Party that the inspection is completed.

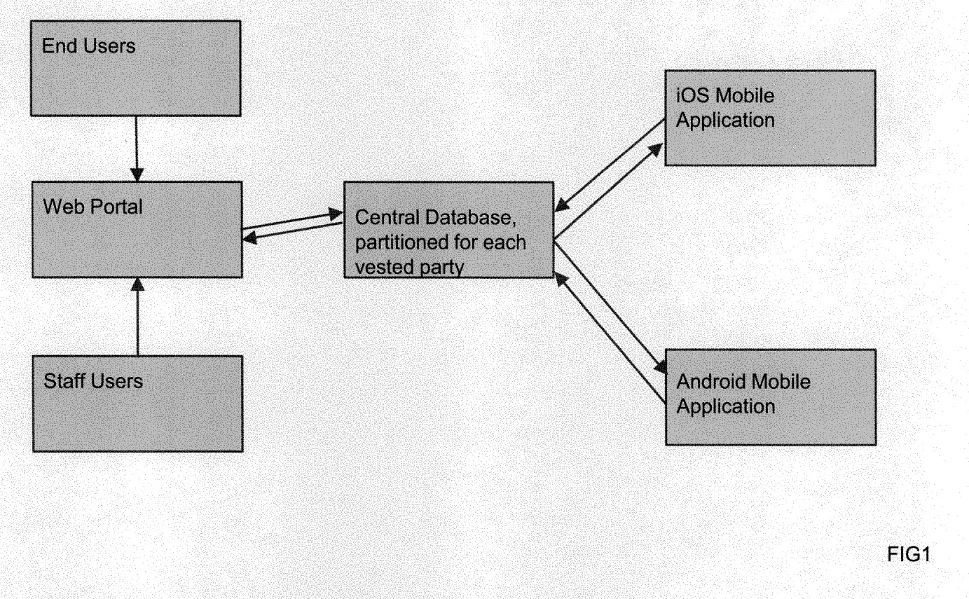

FIG. 1 is a high level description of the general system architecture of the invention. The primary interface of the invention with the end users is through the web portal. This web portal is accessed through the user's standard internet browser program. The web portal of the present embodiment is a PHP-based server application, which is currently implemented on an Amazon EC2 virtual server (although could be moved to other server locations, whether customer or company owned, as business needs/security needs prescribe by persons familiar with this type of technology). The web portal of a preferred embodiment of the present invention is built on the Laravel framework (v4.0) with PHP version 5.6.

LIUs, Super Users and Contractors, from the web portal, will access the central database that holds all the data for the invention at this time. The central database is currently located on a separate Amazon EC2 virtual server, which, like the web portal virtual server, could be moved to a different location as needed. The central database is where all data input by users is stored for the invention. It is username and password protected, in order to only allow authorized users to access the data for its clients. The central database uses MySQL version 5.5.

Inspectors will access the central database, in a limited fashion, through either the iOS mobile application or the Android mobile application. These applications, installed on mobile devices through their related online stores, are username and password controlled. Each inspector is further partitioned in the database so that they are only allowed access to data related to the projects that have been assigned to them by the LIUs, as well as the Unassigned projects that are made available to all inspectors at the institutions in which the inspector has been designated as an authorized User. The iOS application is built in Objective-C, while the Android application is built in Java.

It is understood that alternative databases, server applications, programming code and supporting frameworks suitable for the invention currently exist and more will be available in the future with the same, similar or enhanced aspects for carrying out the novel features of the present invention.

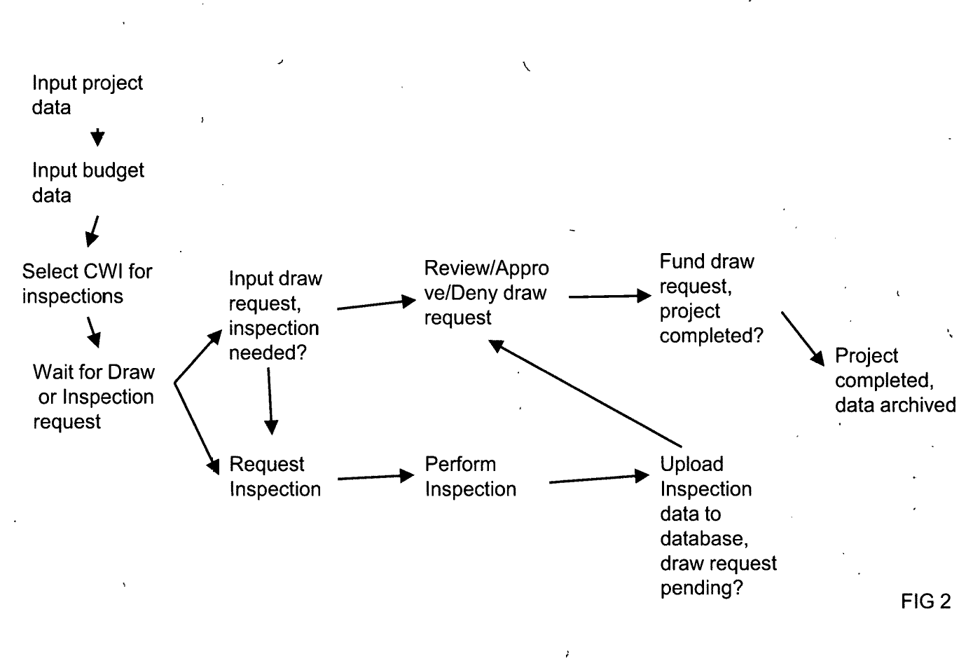

FIG. 2 is an example of the typical flow of work through the invention by the LIUs. When a project is first added to the invention, it will be the duty of the LIUs to enter the pertinent information into the central database. This information will include the following fields:
Loan Number
Name of Borrower
Name of Builder
Building Type (CWI type) (see explanation below)
Project Address
Legal Description
Closing Date
Maturity Date
Approval Level (in the invention system)
Loan Officer
Inspector
Sources of Funds

Other fields may be added by a Super User or Staff User as appropriate to an account.

The LIU will also be required at the same time to either manually enter or import a detailed budget for the project. This budget may be typed into the database, line by line, or, if saved by the user as a .csv (comma separated values) file, may be imported electronically into the database. The budget, whether manually entered or imported, will require the following fields:
Line Item Number
Line Item Name
Dollar Amount
Designation of either Hard or Soft cost

Other fields may be added by a Super User or Staff User as appropriate to an account.

Explanation of CWIs: Building Types/Completion Weighting Item (CWI) types are created by the Super Users at each institution. They are used for a variety of projects, potentially simultaneously. CWIs are the line items that are used by the inspectors to determine the percentage of completion for a project. CWIs may or may not be similar to the budget line items for a project. The intention is that an institution will set up a number of CWIs in the system for the different types of buildings that are in its portfolio. Some examples of CWI types may include Single Family Custom, Single Family Tract, Multi-Family, Commercial, Land Development, etc.

Once Super Users determine the name for the CWI listing, they are then prompted to input the list of individual line items and their relative portion of the overall percentage of the project that they represent (the portions must total 100%). It is also contemplated that fields are available for custom entries, and as weightings are assigned to each line in an already input CWI schedule, the other entries will be adjusted proportionately to total 100%, which in a preferred embodiment is required for the CWI schedule to be accepted into the system. For example, an institution may set up a CWI for a type of project as follows:

| | |
|---|---|
| Excavation | 5% |
| Foundation | 6% |
| Framing | 20% |
| Drywall | 5% |
| Painting | 10% |
| Exterior Siding | 14% |
| Roof | 5% |
| Cabinets/Counter | 10% |
| Floor Coverings | 25% |
| Total | 100% |

When it is time for an inspector to perform an inspection on a property, the inspector will automatically be shown the CWI listing associated with the property they are inspecting. The inspector will then go through the listing of CWIs for this property, assigning each a percentage of completion. An example of an inspector's findings for the percentage of completion during an inspection follows:

| | |
|---|---|
| Excavation | 100% |
| Foundation | 100% |
| Framing | 100% |
| Drywall | 100% |
| Painting | 50% |
| Exterior Siding | 75% |
| Roof | 100% |
| Cabinets/Counter | 0% |
| Floor Coverings | 0% |

The invention will then multiply the percentage of completion for each CWI by the percentage of the overall project that each CWI represents in order to determine the overall percentage of completion of the project, as follows:

| | |
|---|---|
| Excavation | 5% × 100% = 5% |
| Foundation | 6% × 100% = 6% |
| Framing | 20% × 100% = 20% |
| Drywall | 5% × 100% = 5% |
| Painting | 10% × 50% = 5% |
| Exterior Siding | 14% × 75% = 10.5% |
| Roof | 5% × 100% = 5% |
| Cabinets/Counter | 10% × 0% = 0% |
| Floor Coverings | 25% × 0% = 0% |
| Total Percentage Complete = | 56.5% |

In this example, using the selected CWI listing, and based on the most recent inspection performed on the property, the construction project would be deemed to be 56.5% completed.

Using the Web Portal: Once the LIU has input the pertinent project data and the required budget data, the project will stay in the database, unchanged, until such time as a Draw Request and/or an Inspection Request is made.

Draw Requests: In the construction and development lending field, it is common practice for construction or development loans to be made using what is called a “Draw Down Line of Credit”. In basic terms, this means that the borrower is approved for a total loan amount, however at the initial closing of the loan, only the amount of monies needed up to that point are actually advanced on the loan and are accruing interest. Each advance on the loan is known as a “draw”, and the borrower is usually allowed to make draws on the loan up to a total of the loan amount. Each “draw” is usually requested by the borrower of the lender, and usually lists out specifically which invoices/costs are to be paid on the project. As the lender typically has the final approval authority, the package the borrower submits to the lender that lists out each vendor/contractor to be paid is referred to as a “draw request”.

When a draw request is presented to the institution, the LIU will either manually input the budget line item numbers and the related dollar amounts for the draw request on the project, or import the same data into the database, again utilizing a .csv file for the import process. When the LIU is creating the draw request in the program, they are allowed to request an inspection be performed on the property by an inspector prior to the approval of the draw request. In an alternate embodiment of the invention, the Contractor user is able to input manually or import into the database each draw request, thereby bypassing the LIU's input duties and further speeding the draw request approval process. In a further enhancement, it is envisioned that sub-contractors and suppliers of the Contractor would be able to access the database as limited Contractor users and input the amounts due them, which would then be automatically bundled together periodically to become draw requests the Contractor would acknowledge electronically, thereby again triggering a draw request in the program.

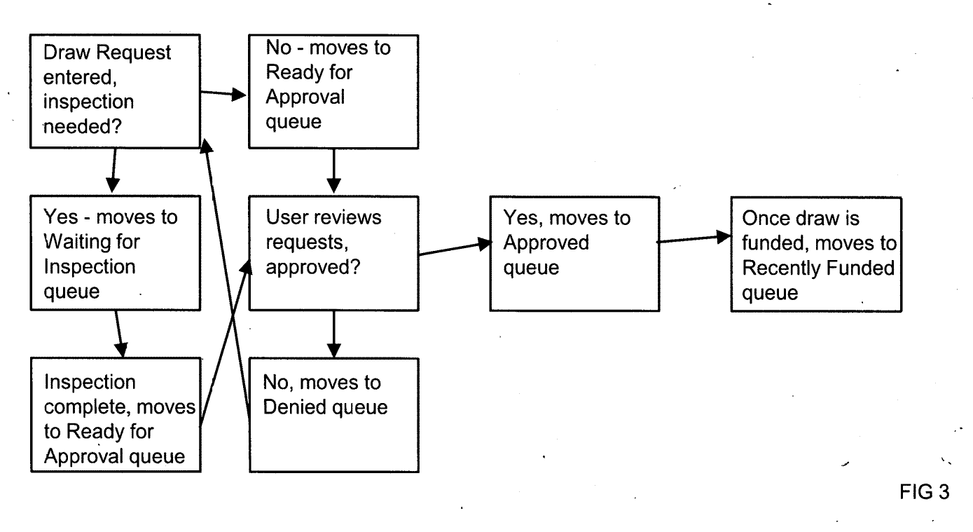

FIG. 3 is a flowchart of a draw request's movements through the invention's queue system. If the LIU determines an inspection is needed prior to approval of the draw request, the project goes into the queue named “Waiting for Inspection”. When a project enters this queue, it is now listed for the inspectors to perform an inspection, and is either assigned to a specific inspector or is placed in the institution's Unassigned listing of inspection requests, which any designated inspector may complete. If the inspection request is assigned to a specific inspector, the invention will automatically send an email notification to the inspector that the institution is requesting the inspector to perform the inspection.

Once the inspection is completed by an inspector using the mobile application, the project is moved to the “Ready for Approval” queue. This is also the queue the project would automatically go into if the LIU were to determine that an inspection is not required prior to approval of the draw request. Once in the “Ready for Approval” queue, the project is waiting for an LIU with approval authority in the invention equal to or greater than the approval level that was set for this project at initial setup to continue the project's approval process.

In order to approve the pending draw request, the LIU with the required approval authority will review in the invention the draw request, as well as having access to view all previous draw requests and inspections. In addition, the LIU will be able to view the budget for the project as if the subject draw request were already funded. At this point, the LIU is able to change the queue for this project from “Ready for Approval” to either “Approved” or “Denied”.

If a draw request is moved to the “Denied” queue, the draw request is not funded, and is basically placed in limbo. At this point, it is expected the institution would communicate with the Borrower to determine if the existing draw request should be amended and then approved, or considered cancelled/withdrawn, and therefore not funded by the institution.

If the draw request is moved to the “Approved” queue, it then waits in that queue until an LIU changes the draw request, placing it into the “Recently Funded” queue. This separation between the “Approved” and “Recently Funded” queues is due to the assumption that typically different staff will be responsible for approving draw requests versus actually funding them. Once the draw request is moved to the “Recently Funded” queue, it will stay there for a ‘waiting period’ of 30 days or other appropriate period that may be designated by a Super User or Staff User of the system. During that period, if a new draw request is entered into the system, the project will revert back to either the “Waiting for Inspection” queue or the “Ready for Approval” queue. Should there not be any further draw requests during the waiting period, the project will drop out of the queue system, and will be listed as having a queue status of “None” or “Inactive”.

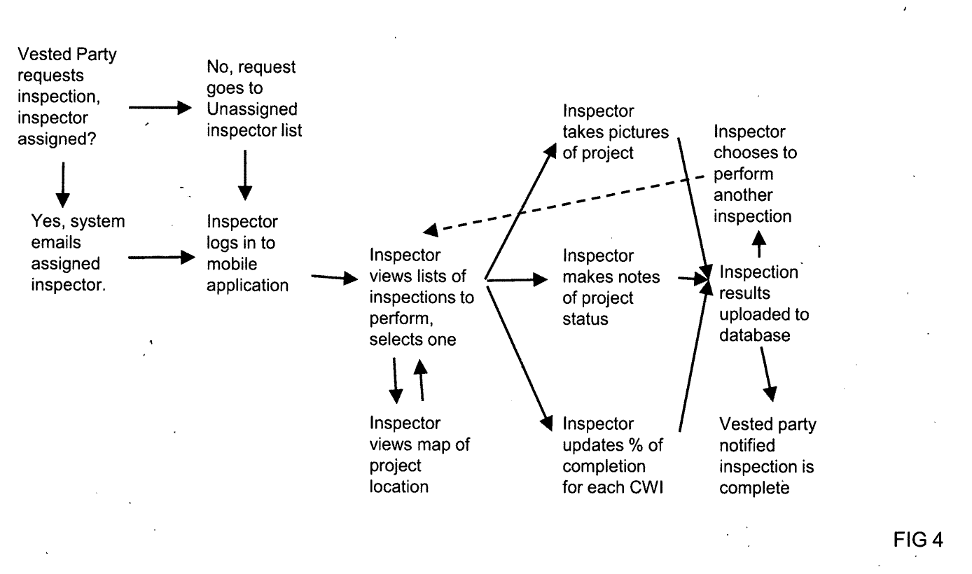

FIG. 4 is a flowchart of an inspection request's movements through the invention's queue system. It is not necessary for a draw request to be input into the invention in order for an inspection to be requested. LIUs are able to request an inspection at any time. The invention's web portal includes a screen which lists every project in the portfolio, and the LIU may choose to sort them by Name, Number or Date of Last Inspection. The LIU may then select from the list any and all projects they wish to have inspected.

If an inspector is assigned to the project, the system will communicate with the inspector through electronic communication via email, text or pager, or other means (the present embodiment utilizes the Mandrill email system) to send an email to the inspector immediately, notifying the inspector that an inspection has been requested, and on what project. The project is then displayed in the inspector's list of “Assigned” inspection requests to be performed. If an inspector is not assigned to the project, no communication is sent, and the project is then displayed in the “Unassigned” inspection request list, and thus viewable by all inspectors at the institution. It is also understood than an automated or personal phone call can be designated as a communication preference, and could be made to the inspector at the appropriate time upon prompt by the system, with notification that the inspector services are needed.

Inspectors will utilize the invention's mobile applications for iOS and Android to proceed with the inspection requests. Once they have signed in to the application from their mobile device, the inspector will be able to view the “Assigned” list of projects they are to inspect, as well as the “Unassigned” list of projects, which they may inspect. Basic project data will initially be displayed to the inspector. The inspector is also able at this point to select the address for a project, and they will be redirected to a mapping function on their mobile device, where a map of the project location may be displayed, with the ability to have turn by turn navigation directions to the project shown to them.

The inspector then may choose a project on which to perform an inspection by selecting the project's identifying number. At this point, the inspector will be taken to the Assignment Details screen, on which they have a link to the previous inspections performed, the draw request history, the legal description for the property, the percentage of completion from the previous inspection, the date of the previous inspection, the date of the most recent draw request and the date of the most recent inspection request. Below that will be listed all the CWIs, with each CWI's percentage of completion from the most recent inspection next to it. There is also a section for photographs and notes that are taken during the inspection. Finally, there is a button the inspector may select that is named “Begin Inspection”.

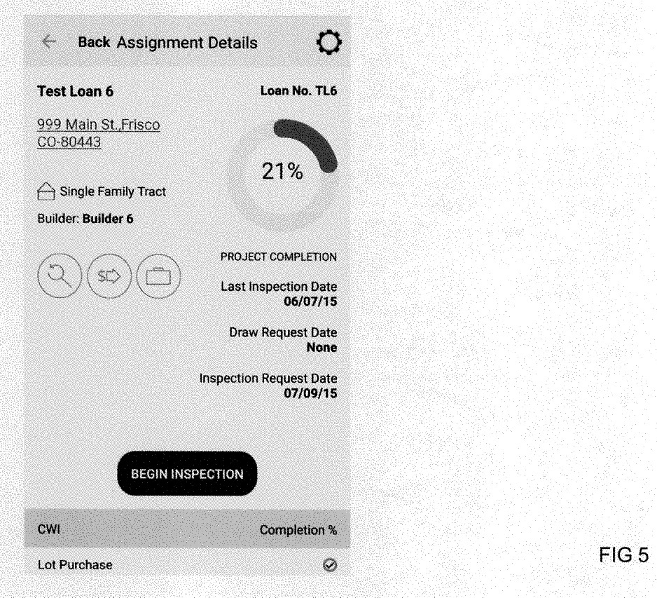

FIG. 5 is a screenshot of a user interface screen of the system described in the present invention. When the inspector selects the “Begin Inspection” button as illustrated on the user interface screen of FIG. 5, the screen brings up each CWI, in order, with a circular graphic representing the most recent percentage of completion. The inspector manipulates the graphic to shift the percentage of completion in 5% increments to represent the actual percentage of completion currently for that CWI. The inspector may also select the related buttons to add a photo and/or add a note to that particular CWI. When the inspector has completed updating that CWI, they select a button named “Confirm”, and are brought to the next CWI in the list. Inspectors are also able to move between CWIs, and are not required to inspect the CWIs in any particular order.

Once each CWI inspection has been updated, the inspector is brought back to the Assignment Details screen. On this screen, they may review each CWI, the photos taken and the notes added. Once the inspector is satisfied with the inspection, they select the button marked “Submit Inspection”. Once the inspection is submitted, the data is uploaded to the database. At that point, the LIU assigned to the project is notified via the Mandrill email system that the inspection has been uploaded, and the inspector is also notified that the inspection was successfully uploaded. All LIUs with the proper authority levels are then able to view the results of the inspection in the web portal.

It is understood that specific functional details disclosed herein are merely representative for purposes of describing embodiments. Embodiments may, however, be embodied in many alternate forms and should not be construed as limited to only the embodiments set forth herein.

It should also be noted that in some alternative implementations, the functions/acts noted may occur in a different sequence of the order noted in the figures. For example, two figures shown in succession may in fact be executed substantially concurrently or may sometimes be executed in the reverse order, depending upon the functionality/acts involved.

With the above embodiments in mind, it should be understood that the embodiments employ various algorithm-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The embodiments can also be embodied as computer readable code on a computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microproccssor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, and described operations may be adjusted so that they occur at slightly different times or the described operations may be distributed in a system which allows the occurrence of the processing operations at various intervals associated with the processing.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the claims that will be presented.

What is claimed is:

1. A computing system for tracking a budget for a project having a plurality of project participants at multiple locations, comprising:
A database for storing data from one or more project inspection reports;
A database for storing a project budget; and
A computer that includes a processing circuit, and that is configured to:
receive a project inspection reports from a participant of the plurality of project participants;
direct the one or more inspection reports to the database;
receive a request for a draw from the project budget by a second participant of the plurality of project participants;
determine an outcome of the draw request based on the one or more inspection reports;
provide the draw request participant with a notice of the outcome determination of the draw request;
update the project budget according to the outcome of the draw request.

2. A computing system of claim 1, further comprising a personal electronic device for use by each of the plurality of project participants to interface with the system.

3. A computing system of claim 1, further comprising a database for storing data for the draw request.

4. A computing system of claim 1, wherein a second inspection report is received by a third participant of the plurality of project participants.

5. A method for tracking a budget for a project having a plurality of project participants at multiple locations, comprising the steps of:
Storing a project budget in a database;
Receiving one or more project inspection reports from a participant of the plurality of project participants;
Storing the data from the one or more project inspection reports to a database;
Receiving a request for a draw from the project budget from a second participant of the plurality of project participants;
Determining an outcome of the request for a draw from the project budget;
Providing the second participant with a notice of the outcome determination of the draw request;
Updating the project budget according to the outcome of the draw request.

6. The method according to claim 5, wherein the project participants use a personal electronic device to interface with a computer processor of the system.

7. The method according to claim 6, wherein a participant uses a personal electronic device to submit a project inspect report including pictures taken by the device.

8. The method according to claim 5, wherein a participant uses a personal electronic device to check a status of the project.
